(19) United States
(12) Patent Application Publication
(10) Pub. No.: US 2017/0243259 A1
(43) Pub. Date: Aug. 24, 2017

(54) ESPORTS AMATEUR COMPETITORS' LEAGUE FRANCHISE OPPORTUNITY

(71) Applicant: MICHAEL REDDICK, ORANGE, CA (US)

(72) Inventor: MICHAEL REDDICK, ORANGE, CA (US)

(21) Appl. No.: 15/441,022

(22) Filed: Feb. 23, 2017

Related U.S. Application Data
(60) Provisional application No. 62/298,865, filed on Feb. 23, 2016.

(51) Int. Cl. G06Q 30/02; A63F 13/792; A63F 13/35

(52) U.S. Cl. CPC G06Q 30/0279; A63F 13/35; A63F 13/792

(57) ABSTRACT

A method to provide a source of funding to nonprofits comprising: payment of franchise fee by franchisee; hosting an online gaming tournaments by the franchisee wherein a portion of the franchise fee is used to pay for prizes; and hosting qualifying tournaments for the online gaming tournament by the franchisee, wherein for a predetermined number of qualifying tournaments one cash prize slot is generated; wherein a first portion of the fees are used for cash prize slots and a second portion used for funding of the nonprofits.

### RELATED APPLICATIONS

The present patent application claims the benefit of U.S. Provisional Application No. 62/298,865, filed Feb. 23, 2016, entitled “The Esports Amateur Competitors' League Franchise Opportunity”, in the name of the same inventor and which is incorporated herein by reference in its entirety.

### FIELD OF THE INVENTION

The present invention is related to a business model or method. More specifically, it is a method that helps provide a continuous source of funding to nonprofits, allowing them to provide an array of services.

### BACKGROUND OF THE INVENTION

The present invention was designed to help provide a continuous source of funding to the many nonprofits that provide an array of services. These nonprofit organizations range from those that provide services such as education programs, youth programs, and assistance to the underprivileged, to those that pick up the slack where insurance companies leave off. Without the services that these organizations provide, many communities would not thrive as the vessels of hope that they are today. Unfortunately though, the dilemma of competing for the same donation dollars as all the other nonprofit organizations, which work wonders in the community is an issue. There is a new market, however, that has been carved by the video gaming industry, known as esports, or competitive gaming, that is currently exploding across the globe.

The market for the video gaming industry starts as early as 13 years of age, with the largest of the video gaming industry demographics falling between the ages of 24 to 35 years of age for men. The market for women is 34 to 43 years of age. In the US, the video game industry consists of roughly 155 million gamers, causal as well as hard core and the worldwide gamers number total 1.75 billion.

The present invention is designed to bring gamers/donors and nonprofits together, creating a financially rewarding platform, thereby benefiting all parties involved. We connect a mass market of potential donors with the nonprofit industry, benefitting nonprofit organizations in that they do not incur a great deal of financial burden while competing in such a very competitive market and the donors in that they get to play on one of the most lucrative esports amateur tournament platforms. The present invention essentially removes the risk of associated fees and tournament organization, by utilizing this creative franchise opportunity, so that nonprofits can focus on the business of providing their services not fundraising. The present invention's multiple tournament platform system keeps the talent spread out, so no one person or team can unfairly dominate any EACL tournament.

### SUMMARY OF THE INVENTION

In accordance with one embodiment, a method to provide a source of funding to nonprofits is disclosed. The method comprises: payment of franchise fee by franchisee; hosting an online gaming tournaments by the franchisee wherein a portion of the franchise fee is used to pay for prizes; and hosting qualifying tournaments for the online gaming tournament by the franchisee, wherein for a predetermined number of qualifying tournaments one cash prize slot is generated; wherein a first portion of the fees are used for cash prize slots and a second portion used for funding of the nonprofits.

### BRIEF DESCRIPTION OF THE DRAWINGS

The present application is further detailed with respect to the following drawings. These figures are not intended to limit the scope of the present application but rather illustrate certain attributes thereof.

FIG. 1 is a flowchart showing a method in accordance with one aspect of the present application.

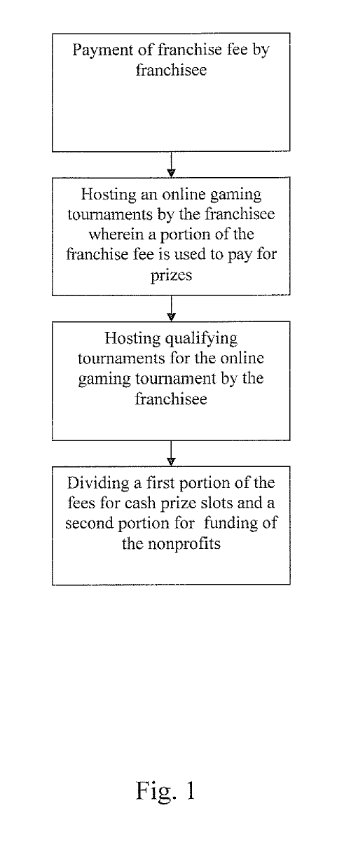

### DETAIL DESCRIPTIONS OF THE INVENTION

All descriptions are for the purpose of showing selected versions of the present invention and are not intended to limit the scope of the present invention.

The present invention involves The Esports Amateur Competitors' League (EACL) is a group of social entrepreneurs, referred to as franchisees. This group of aggressive franchisees will come together to form a unique league of Amateur video game tournaments. The franchisees will sponsor the online gaming tournaments, by buying advertising and sponsoring the cash prize pot. Each franchisee pays a monthly franchise fee of $600 to $1200, in which the fees will be used to sponsor the cash prize pots for their EACL tournaments. This breaks down to $10 per slot. The franchise fees sponsor 6 slots per tournament category to cover not only their EACL slots, but it also covers the cost of the nonprofits slots in each of the final tournament categories.

Each tournament category consists of 128 tournament slots per cash prize pot. The franchisee then holds qualifying tournaments online from their official EACL websites. For each EACL 16 slot qualifying tournament, one cash prize slot is created. A franchisee that operates at full capacity creates 12×$10 slots=120 cash prize round tournament slots in 20 different categories, for every 100 franchisees, the EACL creates 5 cash prize pots per tournament category depending upon gamer participation. A franchise consists of 1920 qualifying tournament slots of which 1600 slots, will be allocated to the United Fundraising League the commercial fundraising entity for EACL. The remaining 320 qualifying tournament slots are the franchisee EACL slots. The franchisee receives 70% per EACL slot and pays out 50% per UFL slot, leaving a 20% payout for each UFL slot for the EACL franchisee. EACL receives 30% of all entry fees and membership fees to cover day to day operations; EACL salaries, admin, IT support, additional membership benefits, and cost to cover licensing fees.

Although the invention has been explained in relation to its preferred embodiment, it is understood that many other possible modifications and variations can be made without departing from the spirit and scope of the invention as herein described.

What is claimed is:

1. A method to provide a source of funding to nonprofits comprising:
payment of franchise fee by franchisee;
hosting an online gaming tournaments by the franchisee wherein a portion of the franchise fee is used to pay for prizes; and
hosting qualifying tournaments for the online gaming tournament by the franchisee, wherein for a predetermined number of qualifying tournaments one cash prize slot is generated;
wherein a first portion of the fees are used for cash prize slots and a second portion used for funding of the nonprofits.
